(19) United States
(12) Patent Application Publication
(10) Pub. No.: US 2020/0117965 A1
(43) Pub. Date: Apr. 16, 2020

(54) RFID TAG

(71) Applicant: NV Bekaert SA, Zwevegem (BE)

(72) Inventors: Geert DROSSAERT, Mortsel (BE); Ruben MAES, Sint-Amandsberg (BE)

(73) Assignee: NV Bekaert SA, Zwevegem (BE)

(21) Appl. No.: 16/493,124

(22) PCT Filed: Apr. 5, 2018
(86) PCT No.: PCT/EP2018/058665

§ 371 Date: Sep. 11, 2019

(30) Foreign Application Priority Data
Apr. 11, 2017 (EP) 17165944.4

(51) Int. Cl. G06K 19/02; G06K 19/077

(52) U.S. Cl. CPC G06K 19/027; G06K 19/07762; G06K 19/07775

(57) ABSTRACT

The RFID tag comprises a transponder chip and an antenna. The antenna is coupled to the transponder chip. The antenna comprises a metal wire or a strand of metal wires. The metal wire(s) comprise(s) a core—sheath structure. The metal wire or the metal wires comprise(s) a core out of a first metal; and a sheath layer. The core is over its full circumference surrounded by the sheath layer out of stainless steel. The first metal has electrical conductivity higher than stainless steel.

### TECHNICAL FIELD

The invention relates to the field of RFID tags.

### BACKGROUND ART

WO2014/204322A1 discloses an RFID tag particularly suitable for use as linen or laundry tag. The RFID tag in a specific embodiment comprises a backing layer, a first adhesive layer overlaying the backing layer, an RFID transponder and antenna overlaying the first adhesive layer, and a second adhesive layer overlaying the RFID transponder and antenna. The layers are laminated together, hermetically sealing the RFID transponder and antenna within the RFID tag. In a preferred embodiment, the antenna comprises an elongated multi-strand stainless steel wire, e.g. having 49 strands. The wire is preferably between 0.3 and 0.5 mm in diameter, and encapsulated in a nylon or other polymer insulation. Such a multi-strand wire structure measuring 0.3-0.5 mm in diameter with 49 strands has been found to have sufficient flexibility and be less prone to kinking than prior art antennas. The antenna can be stitched to a reinforced adhesive layer prior to lamination. The stitching may comprise a cotton, polyester-cotton, or other substantially durable thread, and preferably holds the antenna in position during lamination and, in combination with the reinforced adhesive layer, subsequent use of the RFID tag.

US2014209690A1 describes RFID tags wherein the antenna can be a stainless steel wire or a copper wire, with a diameter of 0.02-0.045 mm.

### DISCLOSURE OF INVENTION

The first aspect of the invention is an RFID tag comprising a transponder chip and an antenna. The antenna is coupled to the transponder chip. The antenna comprises—and preferably consists out of—a metal wire or a strand of metal wires. The metal wire(s) comprise(s) a core—sheath structure. The core—sheath structure comprises a core and a sheath layer. The core is provided out of a first metal. The core is over its full circumference surrounded by the sheath layer. The sheath layer is provided out of stainless steel. The first metal has electrical conductivity higher than stainless steel.

The RFID tag of the invention has the benefit that its presence is less noticed in clothing. This leads to fewer nuisances in the clothing manufacturing process and a better comfort for the person wearing the clothing product comprising such RFID tag. The presence of the RFID tag is less noticed, thanks to the combined features of the antenna of the RFID tag. The antenna is thin and flexible while providing its functionality as antenna in an optimum way thanks to its good electrical conductivity. It is a further benefit that the RFID tag comprises an antenna that is very durable, it resists very well to laundry processes and can withstand multiple bending.

The metal wire or metal wires used in the invention can be made according to the known techniques strip cladding or insertion of a wire in a tube. In the technique of strip cladding, a strip of stainless steel is shaped into a tube form around a core wire out of first metal; after shaping into tube form, the strip is closed via welding. Alternatively the layer out of stainless steel can be applied by inserting a core wire out of first metal in a tube out of stainless steel and closing the tube thereafter around the core wire by conventional drawing techniques known by the person skilled in the art.

After applying any of the techniques that allow the application of the layer of stainless steel around the core, the metal wire can be drawn to the final diameter by means of known wire drawing processes.

In a preferred embodiment the antenna yarn comprises—and preferably consists out of a strand of metal wires. The strand can be cabled or twisted together; or can comprise parallel wires without twist and without cabling. When the stand is cabled or twisted, preferably the number of turns per meter length with which the stand is cabled or twisted is less than 120 turns per meter, more preferably less than 100 turns per meter.

Preferably, the antenna has a diameter less than 250 μm. The smaller the antenna, the less the RFID tag will be noticeable to its user.

In a preferred embodiment wherein the antenna comprises a strand of metal wires; the ratio of the area of the core to the area of the sheath layer out of stainless steel is more than 1.2; and preferably more than 1.5; even more preferably more than 2.

Preferably, the antenna comprises a strand of metal wires; and the metal wires have a diameter less than 30 μm; preferably less than 25 μm. Fine wires provide closer packing in the antenna, such that the RFID tag is less noticed by its user, e.g. of RFID tags on labels in clothing.

In a preferred embodiment, the antenna comprises one or a plurality of metal wires; and a polymer monofilament or a polymer yarn. The metal wire of the plurality of metal wires; and the polymer monofilament of the polymer yarn can be combined into a cable by means of twisting or cabling, preferably with less than 120 turns per meter twist, more preferably with less than 100 turns per meter twist. It is a benefit of such antenna that a higher strength antenna is obtained. Preferred polymer yarns for use in such embodiments of the invention are aramid yarns—more preferably para-aramid yarns (e.g. as known under the trademark Kevlar)-, polyester yarns—more preferably high tenacity polyester yarns-, polyamide yarns—more preferably high tenacity polyamide yarns-, high-tenacity polyethylene yarns (e.g. as known under the trademark Dyneema), or a multifilament yarn spun from liquid crystal polymer (e.g. a multifilament yarn known under the trademark Vectran).

The antenna can e.g. be coupled to the transponder chip in an inductive way, or physically, e.g. via soldering.

Preferably, the metal wire or metal wires have a circular cross section. More preferably, the core has a circular cross section and the sheath layer out of stainless steel is concentric with the core.

Preferably, the antenna comprises a strand of metal wires; and the metal wires have a hexagonal cross section. Such cross section provides the benefit that a closer packing of the metal wires in the antenna is obtained; synergistically contributing to an RFID tag that is less noticed by the user; e.g. of RFID tags put on a label in clothing. More preferably the metal wires have a diameter less than 30 μm; preferably less than 25 μm.

Preferably, the diameter of the metal wire or of the metal wires is less than 200 μm, more preferably less than 150 μm, even more preferably less than 120 μm.

Preferably, the diameter of the metal wire or of the metal wires is more than 40 μm, more preferably more than 60 μm, even more preferably more than 70 μm.

Preferably, in the cross section of the metal wire(s); the ratio of surface area of the core to the surface area of the sheath layer out of a stainless steel is between 1.5 and 0.25, preferably between 1.25 and 0.4; more preferably between 1 and 0.4. Because of this minimally required thickness of the layer out of stainless steel, the layer of stainless steel provides functionality beyond just a surface layer; e.g. beyond a surface layer for corrosion resistance only; but has a significant effect on mechanical and electrical properties of the antenna, thereby synergistically contributing to the beneficial effects.

In a preferred embodiment, the antenna comprises a strand of metal wires; and the ratio of the area of the core to the area of the sheath layer out of stainless steel is more than 1.2; preferably more than 2; more preferably more than 3.

Preferably, the antenna comprises an insulating polymer layer surrounding the metal wire or the strand.

Preferably, an insulating polymer layer is provided by a wrap of one or of a plurality of yarns; or the insulating polymer layer is provided by a wrap of one or of a plurality of polymer tapes. Such embodiments provide an effective insulation while providing a thin antenna. Furthermore, such antenna has a more textile character. The antenna is even thinner when the insulating polymer layer is provided by one or by a plurality of insulating polymer tapes. Preferably, polyester tapes, polypropylene tapes or polyethylene tapes are used.

More preferably, the yarn or yarns, or the tape or tapes is/are wrapped around the metal wire or around the strand with more than 1000 turns per meter length of the metal wire or of the strand. Preferred material for the insulating wrap is a polyester yarn or polyester yarns. Even more preferred are texturized polyester yarns, more preferably non-entangled texturized polyester yarns.

A tape is a particular type of monofilament yarn: a tape has a cross section that is substantially flat, showing a thickness and a width. Preferred tapes for use in the invention have a width over thickness ratio of the cross section of at least 10, preferably at least 15. Preferably, the width over thickness ratio of the tapes is lower than 50, more preferably lower than 35. Preferred is where the windings of the tape are not overlapping, but touching each other in subsequent turns of wrapping.

Such tapes in polyester, polyamide, polyolefin (e.g. polyethylene or polypropylene) can be used. Polyester tapes are preferred however, thanks to their interesting combination of properties.

Preferred tapes have a cross section with a thickness between 10 and 40 μm, more preferably between 10 and 25 μm, even more preferably between 12 and 25 μm. Preferably the width of the cross section of the tape is at least 100 μm, more preferably at least 200 μm, even more preferably at least 300 μm. Preferably the width of the tape is less than 500 μm.

Specific examples of cross sections of tapes that can be used in the invention are e.g. 250 μm by 12 μm, 350 μm by 12 μm, 370 μm by 12 μm and 250 μm by 23 μm, e.g. in polyester.

Wrapping yarns that can be used in the invention are e.g. multifilament yarns, spun fiber yarns or monofilaments. Preferred multifilament wrapping yarns are texturized multifilament yarns, e.g. polyester multifilament yarns. More preferred are non-entangled texturized multifilament yarns, because they provide best coverage.

Preferably, an insulating polymer layer is provided by a wrap of one or of a plurality of yarns; or the insulating polymer layer is provided by a wrap of one or of a plurality of polymer tapes. The metal wire or the strand is wrapped by a first yarn or by a first tape in S-direction; and the metal wire or the strand is wrapped by a second yarn or by a second tape in Z-direction. Such embodiments provide a particularly effective insulation on the antenna. The direction of wrapping of yarns is indicated by the capital letters S or Z. The wrapping is in S-direction if when the wrapped yarn is held vertically, the wrapping spirals slope in the same direction as the middle portion of the letter S. The wrapping is in Z-direction if when the wrapped yarn is held vertically, the wrapping spirals slope in the same direction as the middle portion of the letter Z.

More preferably, the number of turns per meter with which the first yarn or first tape is wrapped around the metal wire or around the strand is the same as the number of turns per meter with which the second yarn or second tape is wrapped around the metal wire or around the strand. The advantage of such embodiments is that a more stable antenna is obtained.

Preferred material for the insulating wrap is polyester yarn or polyester yarns. Even more preferred are texturized polyester yarns.

Preferably, an insulating polymer layer is provided by a polymer coating, e.g. an extruded polymer coating or a lacquer coating. The insulating polymer coating can e.g. be PVC, PVA, PTFE, FEP, MFA, PFA or PU. Preferably, the thickness of the electrical insulation should not be too thin and not be too thick. If too thin, it is hard to obtain a complete coverage of the filament with the coating. If too thick, the flexibility of the filament decreases. Preferably, the thickness of the insulation coating is between 1 μm and 10 μm. More preferably, the insulation coating is between 3 μm and 7 μm thick. In more preferred embodiments, an extruded coating has a thickness more than 0.1 mm, e.g. more than 0.2 mm; more preferably less than 0.3 mm.

The invention has the additional synergistic benefit that the antenna does not provide a signal when a sensor employing a magnetic field is used; e.g. for the detection of metal parts, e.g. needles, during or after clothing manufacturing. Consequently, less nuisance is created in the manufacturing process of clothing comprising the RFID tag. More preferably, the first metal is copper or a copper alloy. Preferably, the stainless steel layer has an end drawn microstructure. With an end drawn microstructure is meant a microstructure which comprises substantially non-equiaxed grains. Preferred embodiments have in the cross section of the metal wire or metal wires; a ratio of surface area of the core to the surface area of the layer out of stainless steel between 1 and 0.4, more preferably between 0.8 and 0.4. In a preferred embodiment, the sheath layer out of stainless steel has an annealed microstructure. An annealed microstructure is a recrystallized microstructure which comprises substantially equiaxed grains. Annealing can be performed by a heat treatment process in which the stainless steel is heated to above its recrystallization temperature, maintaining a suitable temperature during a certain period of time, and then cooling. The annealing process removes martensite formed during drawing of stainless steel and recrystallizes the stainless steel, resulting in substantially equiaxed grains.

The stainless steel can be selected from the AISI 300 series such as AISI 302, 304, 316 or 316L, AISI 400 series such as AISI 430, AISI 625 or AISI 904. Particularly preferred are AISI 316 and AISI 316L. The first metal has electrical conductivity higher than stainless steel, e.g. copper or a copper alloy.

The second aspect of the invention is a label comprising a textile carrier and an RFID tag as in the first aspect of the invention. The RFID tag is bonded onto the textile carrier. In a preferred embodiment, the antenna is integrated into or onto the textile carrier by means of textile yarns. More preferably, the antenna is integrated into the textile carrier, e.g. by means of a weaving, knitting or embroidery process. The antenna can e.g. be integrated onto the textile carrier by means of one or a plurality of stitching yarns. The antenna can e.g. be integrated into or onto the textile carrier by fixing the antenna between knitting yarns. The antenna can e.g. be integrated into or onto a woven textile carrier by fixing the antenna yarns between weft and warp yarns of the woven textile carrier.

A third aspect of the invention is an apparel product comprising an RFID tag as in any embodiment of the first aspect of the invention; or comprising a label as in any embodiment of the second aspect of the invention. Preferably, the label is attached to the apparel product.

### BRIEF DESCRIPTION OF FIGURES IN THE DRAWINGS

FIG. 1 shows the cross section of a metal wire as can be used in the invention.

FIG. 2 shows the section in a plane through and along the axis of an antenna for an RFID tag according to the first aspect of the invention.

FIG. 3 shows a textile label comprising an RFID tag fixed onto it.

### MODE(S) FOR CARRYING OUT THE INVENTION

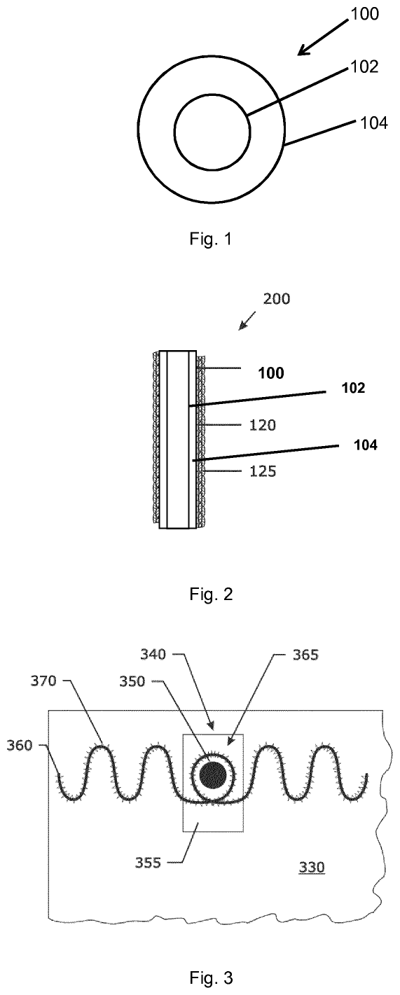

FIG. 1 shows the cross section of a metal wire 100 as can be used in the antenna for an RFID tag according to the invention. The metal wire 100 comprises a core 102 out of a first metal, e.g. copper. The core 102 is over its full circumference surrounded by a sheath layer 104 out of stainless steel, e.g. AISI 316 stainless steel. In the example, the cross section of the metal wire 100 is circular; and the core 102 has a circular cross section, provided concentrically with the cross section of the metal wire 100. As an example, the diameter of the metal wire is 100 μm, with a diameter 60 μm of the core out of copper; consequently in the cross section of the metal wire; the ratio of surface area of the core to the surface area of the layer out of stainless steel is 0.56.

FIG. 2 shows the section 200 in a plane through and along the axis of an exemplary antenna for an RFID tag according to the first aspect of the invention. The exemplary RFID-antenna has been made using a metal wire 100 as in FIG. 1. The metal wire 100 comprises a core 102 out of a first metal, e.g. copper. The core 102 is over its full circumference surrounded by a layer 104 out of stainless steel. A first wrapping yarn 120 is wrapped in Z-direction around the metal wire. A second wrapping yarn 125 is wrapped in S-direction around the metal wire. The wrapping yarns 120 and 125 create a full coverage of the surface of the antenna. As an example the wrapping yarns 120, 125 can be 167 dTex (=16.7 Tex) non-entangled texturized polyester multifilament yarns, wrapped with 1250 turns per meter length of the metal wire 100 around the metal wire 100. The wrapping non-entangled texturized polyester multifilament yarns cover the full surface of the antenna.

Alternatively, tapes can be used to wrap the metal wire of the antenna. Specific examples of cross sections of tapes that can be used in the invention are e.g. 250 micrometer by 12 micrometer, 350 micrometer by 12 micrometer, 370 micrometer by 12 micrometer and 250 micrometer by 23 micrometer, e.g. in polyester.

As an alternative to wrapping with yarns or with tape, an insulating polymer coating can be extruded on the metal wire, e.g. a PA polymer coating.

FIG. 3 shows a textile label 330 and an RFID tag 340 according to the first aspect of the invention fixed onto the textile label. The RFID tag 340 comprises a transponder chip 350 and an antenna 360 as in the first aspect of the invention, e.g. the exemplary antenna of FIG. 2. The antenna 360 is positioned undulating on the textile label and forms in the middle of its length a loop 365 with overlapping ends. The antenna 360 is inductively coupled to the transponder chip 350. The RFID tag 340 is fixed onto the textile label. The antenna 360 is fixed onto the textile label 330 by means of one or more than one stitching yarns 370. The transponder chip 360 is fixed onto the textile label by means of an, e.g. transparent, laminating foil 355. Alternatively, the transponder chip can e.g. be fixed onto the textile label by means of epoxy blob or glue.

An alternative example of antenna that can be used in the RFID tag according to the invention—e.g. in the exemplary tag shown in FIG. 3—comprises a strand of three metal wires as antenna. The three metal wires are twisted together with 80 turns per meter. Each of the three metal wires has diameter 80 μm, with a diameter 48 μm of the core out of copper; and a surrounding layer of 16 μm thickness of stainless steel. The so-formed antenna comprises a wrap in S- and in Z-direction—with 1250 turns per meter—with 167 dtex texturized polyester multifilament yarn to provide an insulating polymer layer on the antenna. As an alternative to the yarns wrapped around the strand of metal wires, a polymer extrusion coating can be applied to the strand; e.g. a PA coating of 0.12 mm thickness.

An alternative example of antenna that can be used in the RFID tag according to the invention—e.g. as in the exemplary tag shown in FIG. 3—comprises a metal wire twisted together with a multifilament para-aramid yarn, e.g. twisted together with 80 turns per meter. This way, a higher strength antenna yarn is obtained. The metal wire has 100 μm diameter, with a diameter 60 μm of the core out of copper; and a surrounding layer of 40 μm thickness of stainless steel. The antenna comprises a wrap in S- and in Z-direction with 167 dtex texturized polyester multifilament yarn to provide an insulating polymer layer on the antenna.

1. RFID tag, comprising
a transponder chip; and
an antenna;
wherein the antenna is coupled to the transponder chip;
wherein the antenna comprises a metal wire or a strand of metal wires;
wherein the metal wire(s) comprise(s) a core—sheath structure;
wherein the core—sheath structure comprises a core and a sheath layer;
wherein the core is provided out of a first metal,
wherein the core is over its full circumference surrounded by the sheath layer;
wherein the sheath layer is provided out of stainless steel; and
wherein the first metal has electrical conductivity higher than stainless steel.

2. RFID tag as in claim 1; wherein the antenna has a diameter less than 250 μm.

3. RFID tag as in claim 1, wherein the antenna comprises a strand of metal wires; and wherein the ratio of the area of the core to the area of the sheath layer out of stainless steel is more than 1.2.

4. RFID tag as in claim 1, wherein the antenna comprises a strand of metal wires; and wherein the metal wires have a diameter less than 30 μm.

5. RFID tag is in claim 1;
wherein the antenna comprises an insulating polymer layer surrounding the metal wire or the strand of metal wires.

6. RFID tag as in claim 5, wherein the insulating polymer layer is provided by a wrap of one or of a plurality of yarns; or wherein the insulating polymer layer is provided by a wrap of one or of a plurality of polymer tapes.

7. RFID tag as in claim 6;
wherein the yarn or yarns, or the tape or tapes is/are wrapped around the metal wire or around the strand with more than 1000 turns per meter length of the metal wire or of the strand.

8. RFID tag as in claim 6;
wherein the metal wire or the strand is wrapped by a first yarn or by a first tape in S-direction;
and wherein the metal wire or the strand is wrapped by a second yarn or by a second tape in Z-direction.

9. RFID tag as in claim 8; wherein the number of turns per meter with which the first yarn or first tape is wrapped around the metal wire or around the strand is the same as the number of turns per meter with which the second yarn or second tape is wrapped around the metal wire or around the strand.

10. RFID tag as in claim 5, wherein the insulating polymer layer is provided by a polymer coating.

11. RFID tag as in claim 1, wherein the antenna comprises a strand of metal wires; and wherein the metal wires have a hexagonal cross section.

12. RFID tag as in claim 1,
wherein the first metal is copper or a copper alloy.

13. Label comprising
a textile carrier; and
an RFID tag as in claim 1,
wherein the RFID tag is bonded onto the textile carrier.

14. Label as in claim 13; wherein the antenna is integrated into the textile carrier.

15. Apparel product,
comprising an RFID tag as in claim 1.
